(19) United States
(12) Patent Application Publication
(10) Pub. No.: US 2004/0144694 A1
(43) Pub. Date: Jul. 29, 2004

(54) Method and a device for extending the lifetime of a screen-cloth

(76) Inventor: Thor Bjornstad, Mandal (NO)

Correspondence Address: KNOBBE MARTENS OLSON & BEAR LLP, 2040 MAIN STREET, FOURTEENTH FLOOR, IRVINE, CA, 92614, US

(21) Appl. No.: 10/468,245

(22) PCT Filed: Feb. 14, 2002
(86) PCT No.: PCT/NO02/00065

(30) Foreign Application Priority Data
Feb. 23, 2001 (NO) 20010911

(51) Int. Cl. B07B 1/49

(52) U.S. Cl. 209/405

(57) ABSTRACT

A method and means of extending the life of a cloth screen(5), in particular of the type used for screening drill cuttings from drill fluid, where the cloth screen (5) is placed in a covering manner over the through openings (2) of a sieve plate (1), and where, after a period of operation, the sieve plate (1) is turned upside down and that upon the occurrence of a broken wire in the cloth screen (5), an infill plate (20) is sealingly mounted in the opening (2) of the sieve plate that corresponds to the broken wire.

This invention regards a screen of the type used in separation of e.g. drill cuttings from drill fluid. In particular, it regards a screen, hereinafter termed a sieve plate, comprising a load-bearing, generally profiled support plate and a cloth screen bonded to the support plate by an adhesive.

A fine mesh cloth screen is usually manufactured from a wire with a small cross section. Such relatively fine wire is selected because it is desirable to achieve the highest possible fraction of aperture area of the cloth area, and because it is difficult to produce a cloth screen with exact aperture dimensions using a coarse wire.

The use of fine wires in cloth screens results in the cloth screen exhibiting a relatively low tensile strength and resistance to wear. In order to be able to use a fine screen for high screening capacities, it becomes necessary to support the fine mesh cloth screen. Several solutions are known in which the cloth is stretched over a coarser support cloth or glued to the support cloth by means of narrow, suitably spaced glue joints.

In order to facilitate the work of replacing a cloth screen, a number of installations today make use of profiled sieve plates that are matched exactly to the aperture area of the screening apparatus and therefore relatively easy to replace. Sieve plates of this type are provided with a pattern of ribs that form the support portions for a glued-on, fine mesh cloth screen. The sieve plate comprises through openings between the ribs, through which the screened out material can pass. Material that is too large to pass through the cloth screen is carried across the sieve plate until it passes out over one edge of the sieve plate.

The sieve plate may form part of a rotating sieve drum or of a vibrating screening apparatus.

Even when bound to an underlying support screen/plate constructed in the most favourable manner such as described above, the life of the fine mesh cloth screen is relatively short, due to low strength and resistance to wear. The wear manifests itself through the occurrence of broken wires and thereby oversized through openings in the most exposed portion of the fine mesh cloth screen.

The object of the invention is to remedy the disadvantages of prior art.

The object is achieved in accordance with the invention by the characteristics stated in the description below, and in the appended claims.

The method in accordance with the invention is two-part. The first step comprises loosening the sieve plate from the screening apparatus after an empirically determined period of operation, turning it in the plane of the screen, and reconnecting it to the screening apparatus. By so doing, the most worn portion of the cloth screen is removed from the most exposed abrasion area, and another area showing relatively little wear takes up the most abrasive position. This turning of the sieve plate is made possible by those end portions of the sieve plate that correspond to the proximal sieve plate being provided with mouldings that interlock sealingly with an identical moulding belonging to the proximal sieve plate. The sealing joint between the sieve plates is constructed so that the sieve plates fit into each other in a complementary manner regardless of which way around they are mounted. The construction and function of the mouldings are described in greater detail in the specific part of the description.

The second phase of the method is applied when a broken wire occurs in the fine mesh cloth screen. An infill plate, one side of which in a preferred embodiment is equipped with a flexible plate, e.g. rubber, is positioned so as to cover the opening in the sieve plate where the broken wire has occurred, with the flexible material facing downwards and sealing against the fine mesh cloth screen. The infill plate is provided with at least one through fastening device, preferably of a bayonet design, to an underlying anchor plate, where the fastening device fits the corresponding opening of the anchor plate in a complementary manner. The side faces along two of the parallel outer sides of the anchor plate slope inwards so as to form a wedge that tapers towards that side of the anchor plate which faces the cloth screen. The inwardly sloping faces fit in a complementary manner in the corresponding angled portions formed in the longitudinal ribs of the sieve plate. By biasing the anchor plate in towards the sieve plate, the wedging action of the sloping faces causes an increased surface pressure and thereby greater frictional force to occur at the contact surfaces between the anchor plate and the ribs of the sieve plate. The frictional force acting between the anchor plate and the ribs of the sieve plate cause the anchor plate to remain stationary relative to the sieve plate at the level of vibration experienced. Biasing of the anchor plate may be achieved by the use of spring elements under the head of the fastening device, or by elastic buckling of the infill plate and/or the anchor plate.

The following describes a non-limiting example of a preferred embodiment illustrated in the accompanying drawings, in which:

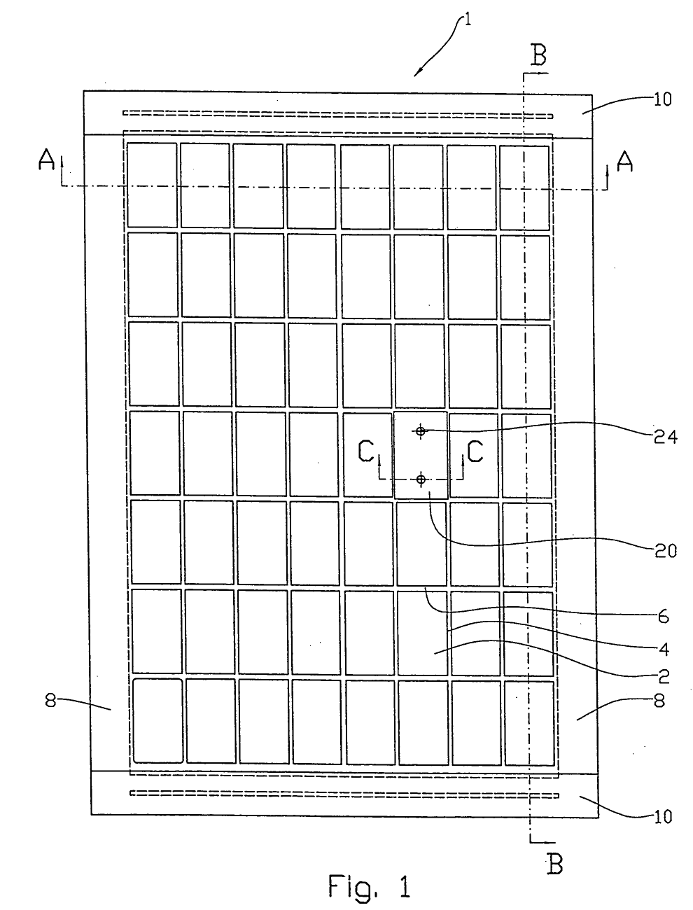

FIG. 1 shows a plan view of a sieve plate according to the invention. The fine mesh cloth screen is not shown;

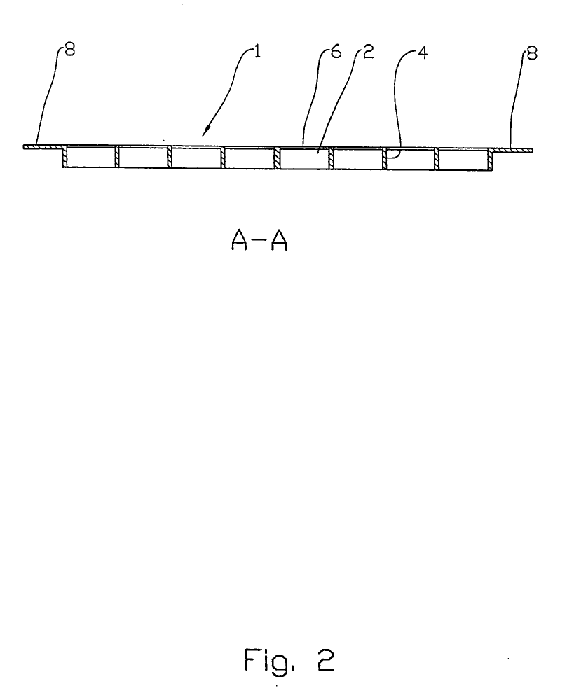

FIG. 2 shows a section A-A in FIG. 1;

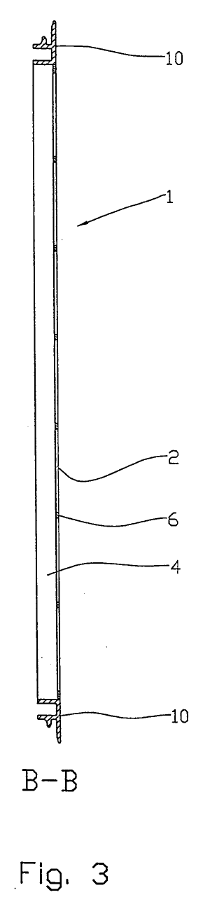

FIG. 3 shows a section B-B in FIG. 1;

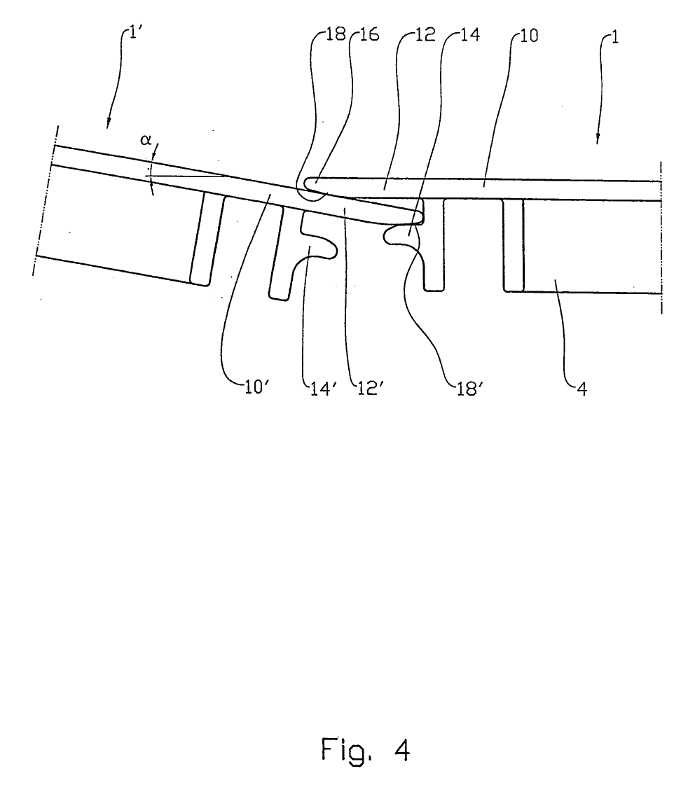

FIG. 4 shows a side view of a cutout of two compound sieve plates on a larger scale; and

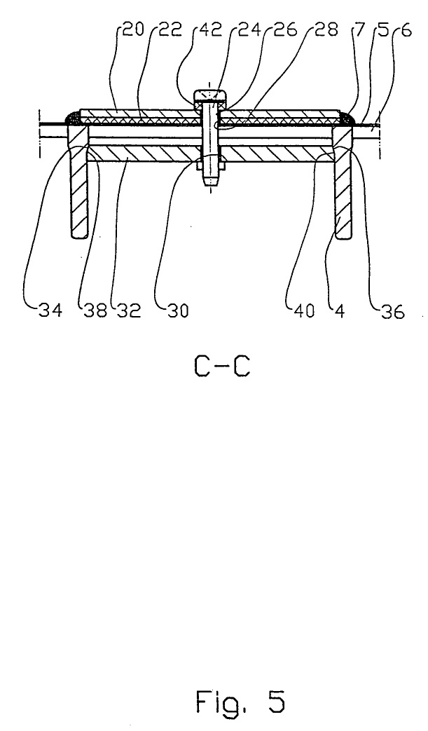

FIG. 5 shows a section C-C in FIG. 1, also showing the fine mesh cloth screen.

In the drawings, reference number 1 denotes a sieve plate comprising a number of through openings 2 positioned between ribs 4 and divided by means of intermediate members 6. A fine mesh cloth screen 5 is bonded to the upper side of the sieve plate 1 in a covering manner by means of an adhesive 7, see FIG. 5. Two of the edges of the sieve plate 1 are provided with connecting strips 8 designed to be coupled to the screening apparatus (not shown) by means of fastening means of a type that is known per se, while the two remaining parallel edges of the sieve plate are provided with mouldings 10.

The mouldings 10 comprise a relatively wide plate portion 12 projecting from the sieve plate and a relatively narrow plate portion 14 also projecting from the sieve plate and located a distance below the first plate portion 12. The underside of the plate portion 12 has a bevel 18 near the outer edge 16 of the plate portion 12.

An infill plate 20 with an intermediate flexible plate 22 is positioned over the fine mesh cloth screen 5, covering a through opening 2 in the sieve plate 1. At least one fastening element 24, preferably in the form of a bayonet coupling, is placed in through openings 26 and 28 in the infill plate 20 and the flexible plate 22, respectively. The fastening element 24 protrudes down through a complementary through opening 30 in an anchor plate 32. Along two of the parallel longitudinal edges 34, 36 of the anchor plate, the sides are formed with sloping faces that in a complementary manner fit the corresponding sloping portions 38, 40 formed on the longitudinal ribs 4 of the sieve plate 1. A spring element 42, e.g. in the form of a rubber bushing, may be provided between the head of the fastening element 24 and the infill plate 24, and be designed to bias the plates 20 and 32 towards the sieve plate 1.

When assembling two sieve plates 1 and 1′ in a screening apparatus of the type in question, the wider projecting plate portion 12′ of the sieve plate 1′ is pushed in between the two projecting plate portions 12 and 14 of the other sieve plate 1. When fastening the sieve plates 1, 1′ in the screening apparatus, the sieve plates 1, 1′ assume positions in which there is a relative angle α between the sieve plates 1, 1′. The bevel 18 is formed so as to a but the upper side of projecting plate portion 12′ in an essentially sealing manner upon said relative angle α, while the corresponding bevel 18′ is biased against the upper side of the projecting portion 14.

The design of the moulding 10 ensures, through its bearing abutment against the complementary, identical moulding 10′, with all reference numbers being marked, that a sealing joint is maintained between the two relatively slender, light sieve plates 1 and 1′ during the vibration of the screening apparatus, and that the plates 1 and 1′, both end portions of which are equipped with identical mouldings 10, may easily be turned upside down, whereby an extended life may be expected.

Upon the occurrence of a broken wire in the fine mesh cloth screen 5, the infill plate 20 and preferably also the flexible plate 22 are positioned in a covering manner over the opening 2 in the sieve plate 1 that corresponds to said broken wire. The anchor plate 32 is positioned in the same opening 2 from below and forced in between the ribs 4 until the sloping edges 34, 36 of the anchor plate stop against the sloping portions 38, 40, respectively, of the ribs 4. The fastening element 24 is connected to the anchor plate 32, causing the plates 20 and 32 to be biased in the direction of the sieve plate 1. By the anchor plate 32 being pulled in towards the sloping portions 38 and 34 of the ribs 4 in a locking manner through said biasing of the fastening device 24, the frictional force that occurs between the anchor plate 32 and the ribs 4 of the sieve plate cause the anchor plate 32 to remain stationary relative to the sieve plate 1 at the level of vibration experienced. The biasing of the anchor plate 32 may be achieved by tensioning the spring element 42, and by elastic buckling of the infill plate 20 and/or the anchor plate 32.

1. A method of extending the life of a cloth screen (5), in particular of the type used for screening drill cuttings from drill fluid, where the cloth screen (5) is placed in a covering manner over the through openings (2) of a sieve plate (1), characterised in that the sieve plate (1) is turned upside down after a period of operation, and that upon the occurrence of a broken wire in the cloth screen (5), an infill plate (20) is fitted in a sealing manner by the opening (2) in the sieve plate that corresponds to the broken wire.

2. A means of extending the life of a cloth screen (5), in particular of the type used for screening drill cuttings from drill fluid, where the cloth screen (5) is placed in a covering manner over the through openings (2) of a sieve plate (1), characterised in that the sieve plate (1) along its end portions is provided with identical mouldings (10) comprising a relatively wide upper projecting plate portion (12) and an underlying, relatively narrow projecting plate portion (14), and where a relatively wide upper projecting plate portion (12′) belonging to an adjacent sieve plate (1′) also provide with the same identical mouldings (10′), is guided in between the two plate portions (12, 14) and through angular displacement (α) between the sieve plates (1, 1′) brought to rest supportingly against the upper projecting plate portion (12) on its upper side and the underlying plate portion (14) on its underside.

3. Means according to claim 2, characterised in that the underside of the edge (16) of the relatively wide projecting plate portion (12) is provided with a bevel (18).

4. A means of extending the life of a cloth screen (5), in particular of the type used for screening drill cuttings from drill fluid, where the cloth screen (5) is placed in a covering manner over the through openings (2) of a sieve plate (1), and where an infill plate (20) is placed in a covering manner over an opening (2), characterised in that the infill plate (20) is coupled to an anchor plate (32) in a biasing manner, preferably by a bayonet device (24), which anchor plate is arranged between the ribs (4) of the sieve plate (1).

5. Means according to claim 4, characterised in that the longitudinal edges of the anchor plate (32) form wedging, sloping landing surfaces (34, 36) against the corresponding sloping landing surfaces (38, 40) of the ribs (4).
